(19) United States
(12) Patent Application Publication
(10) Pub. No.: US 2002/0150311 A1
(43) Pub. Date: Oct. 17, 2002

(54) Apparatus and method for creating images of small documents

(76) Inventor: Eric R. Lynn, Phoenix, AZ (US)

Correspondence Address: Mark F. Wright, Wright Law Group, PLLC, Suite 2, 7201 West Oakland, Chandler, AZ, 85226, US

(21) Appl. No.: 10/161,538

(22) Filed: Jun. 3, 2002

Related U.S. Application Data
(63) Continuation-in-part of application No. 09/436,130, filed on Nov. 8, 1999, now Pat. No. 6,427,032.
Application No. 09/436,130 is a continuation-in-part of application No. 09/001,228, filed on Dec. 30, 1997, now Pat. No. 6,192,165.

(51) Int. Cl. G06K 9/54

(52) U.S. Cl. 382/306

(57) ABSTRACT

According to the preferred embodiments of the present invention, an apparatus and method for creating digital images of small documents such as receipts and the like is disclosed. The invention incorporates a multi-layered document holder with a substantially transparent first layer at least partially connected to a second layer. By inserting small papers such as receipts and the like between the two layers, the document holder can be scanned and digital images of the documents sandwiched between the layers can be created.

### RELATED APPLICATIONS

This application is a continuation in part of U.S. patent application Ser. No. 09/436,130, filed Nov. 8, 1999, which application is now pending and which is a continuation in part of U.S. patent application Ser. No. 09/001,228, filed Dec. 30, 1997, now issued as U.S. Pat. No. 6,192,165, which applications are incorporated herein by reference.

### BACKGROUND OF THE INVENTION

1. Technical Field

This invention generally relates to creating digital images of paper-based documents and more specifically relates to an apparatus and method for creating digital images of small documents.

2. Background Art

While most modern computer systems can be used for business, education and entertainment purposes, the most widespread application for computers today is related to processing information. Word processing, page layout, database, spreadsheet, and desktop publishing applications are used to prepare and disseminate information throughout society. The increased availability of computer systems and computer networks such as the Internet have made vast repositories of information available to a huge segment of our population. Indeed, as it has been widely discussed in the popular media, modem computer systems have brought our world into the “information age.”

One of the promises of the information age ushered in by these omnipresent computer systems was the advent of a “paperless” society. Computers, in theory, would liberate the world from the flood of paper which currently impedes the flow and management of information. Computer-based systems with advanced information processing capabilities would supposedly allow the instantaneous electronic exchange of information from one location to another, without the necessity of “hard copy.” Indeed, many businesses have embraced computer systems with the stated goal of eliminating, or at least significantly reducing, the seemingly endless stream of paper that flows into and out of an office. Reducing the burdens of paper-based information has become a widespread goal. However, the simple truth is that today we have more paper-based information, document processing labor costs, document storage overhead, and hard-copy related dependencies in our society than ever before.

Recognizing this problem, attempts have been made to better manage and control the paperwork that flows into the information stream each and every day. Some of these previously implemented solutions are based around the notion of creating, storing, and accessing electronic images directly in a computer system, bypassing hard copy completely. This solution makes sense only when a company or organization achieves fairly tight control over the generation and use of documents and can, therefore, effectively reduce the paper flow in certain situations. However, much of the paper burden in a given organization is directly attributable to paper-based documents that are generated by external sources. This means that most businesses and organizations, regardless of their internal systems, still receive and process substantial amounts of paper-based information.

Other known solutions include document imaging systems which can scan paper-based documents and store/retrieve the resulting electronic images. Though many different document imaging systems have been commercialized since the late 1980s, none have gained widespread acceptance. Even though the quantifiable burdens of paper information storage, access and management are well known and uniformly decried, document imaging systems have not been broadly adopted as an alternative to the traditional filing cabinet. Document imaging systems today capture less than 1% of paper filing volumes. File cabinets continue to fill up, desktop stacks of paper continue to grow, and many business processes and desktops are still paper-bound. International Data Corporation (IDC) estimates that in 1997, U.S. business spent $25-35 billion on filing, storing and retrieving paper. This number approaches $100 billion when the total life cycle paper management costs are calculated, according to IDC.

The costly, integrated document imaging systems developed for handling the tremendous quantities of paper generated in a typical business generally institute a rigid process for a targeted, high-volume, structured paper flow. Because customized document input sub-systems are justified and built for targeted business applications, they do not adapt well to other, diversified document imaging needs, smaller workgroup filing systems, or ad hoc filing systems. Unfortunately, diverse, smaller workgroup filing, and ad hoc filing systems represent the bulk of paper filing performed in most small and medium sized businesses and many large businesses as well. The paradigm of a document input assembly line does not match up well with many existing paper movement and filing patterns found in most businesses and organizations.

In addition, even with the best of the current document imaging solutions available on the market today, there is still a problem associated with certain types of papers in certain common applications. For example, one of the most problematic and paper-intensive applications that almost all companies have to confront is the issue of expense reports and reimbursement requests. Typically, a business will reimburse employees for expenses that they incur in the normal course of their duties performed for their employer. Some of the most common situations involve employee travel and office supplies.

Most employees who travel on company business will save their receipts and then file a request for reimbursement upon returning to their home office. Unfortunately, where companies have adopted a digital imaging solution for handling paper, this presents a problem. Most typical imaging devices, such as scanners, don't handle small pieces of paper very well. The roller systems are not readily adapted to small receipts and the like. Accordingly, the employee will usually resort to a highly inefficient yet eminently practical solution. This involves taping or gluing the receipts to a standard 8 ½ by 11 piece of paper, photocopying the montage of receipts using the photocopy machine, and then introducing the photo-copied paper as an attachment to the expense report or the request for reimbursement. Not only is this process inefficient and time-consuming, it creates a “second-generation” photo-copy that is almost always less legible than the original receipts. This is because many receipts are generated by low-cost ink-jet and thermal printers that produce low-quality output. Each successive generation of digital images will suffer some degradation in image quality and it is most desirable to use the original documents whenever feasible.

Accordingly, without a more efficient and useful way of capturing digital images of small pieces of paper such as receipts and the like, users of digital imaging systems will be required to use the inefficient techniques of the past and endure the less desirable results associated therewith.

### DISCLOSURE OF INVENTION

According to the preferred embodiments of the present invention, an apparatus and method for creating digital images of small pieces of paper such as receipts and the like is disclosed. The invention incorporates a multi-layered document holder with a substantially transparent first layer at least partially connected to a second layer. By inserting small papers such as receipts and the like between the two layers, the document holder can be scanned and digital images of the papers sandwiched between the layers can be created. When used in conjunction with a digital filing apparatus, such as that disclosed in U.S. Pat. No. 6,192,165, users of the present invention will be able to quickly and easily create digital images of small documents and then manage the digital images of these documents in other useful ways.

### BRIEF DESCRIPTION OF THE DRAWINGS

The preferred embodiments of the present invention will hereinafter be described in conjunction with the appended drawings, wherein like designations denote like elements, and:

FIG. 1 is a block diagram of a digital filing apparatus used for indexing, imaging, storing and retrieving documents in conjunction with a document holder according to a preferred embodiment of the present invention;

FIG. 2 is a block diagram of a computer system suitable for use with the apparatus of FIG. 1;

FIG. 3 is a view of a typical label used in conjunction with a document holder according to a preferred embodiment of the present invention; and

FIG. 4 is a perspective view of a document holder in accordance with a preferred embodiment of the present invention.

### DETAILED DESCRIPTION OF THE DRAWINGS

The present invention discloses a document holder that provides a simple and efficient way to create digital images of small documents such as receipts and the like. The document holder of the present invention can be used in conjunction with a digital filing system such as the one described below.

Detailed Description

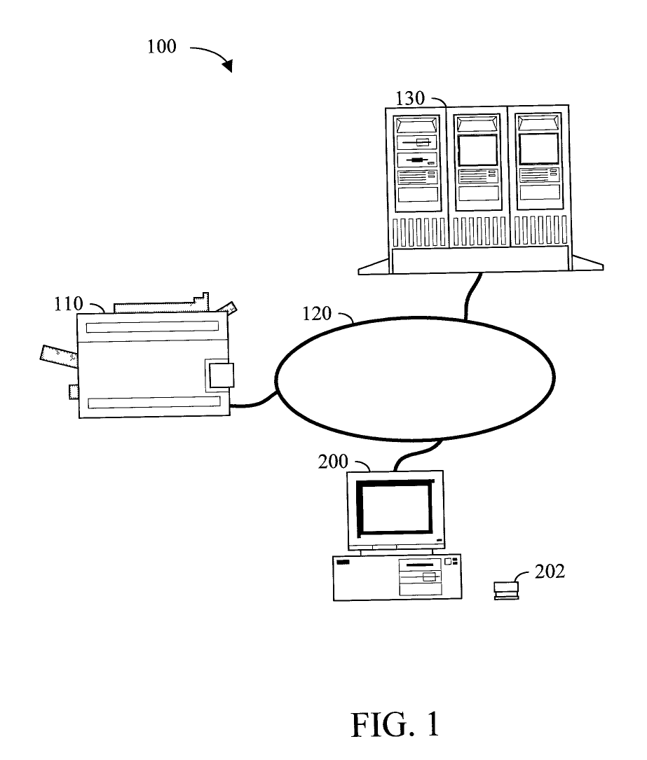

Referring now to FIG. 1, a digital filing system 100 suitable for use in conjunction with a document holder in accordance with a preferred embodiment of the present invention includes: a computer 200; a desktop label dispenser 202; an optional folding out basket 203; a document input mechanism 110; an image storage mechanism 130; and a communication link 120. Taken together, digital filing system 100 provides a way for office workers to index, store, and manage paper-based documents, regardless of their origin.

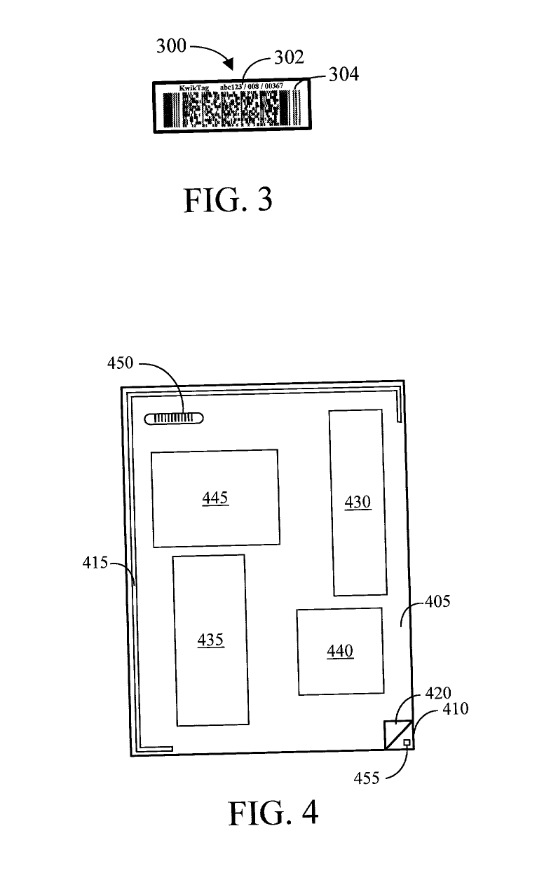

Desktop label dispenser 202 is a specialized device which is capable of dispensing pre-printed labels that will typically include a computer readable globally unique identifier and/or bar code along with corresponding human-readable information (i.e., eye-legible content). The globally unique identifiers, which in the most preferred embodiment are pre-printed on labels contained in desktop label dispenser 202, may be implemented as bar codes that conform to some industry accepted bar code standard such as interleaved 2 of 5, code 39, code 138, PDF 417, or other high-density symbology. Alternatively, proprietary or customized bar code symbologies may be employed in order to further distinguish the pre-printed labels and to enhance the security of the labels. Preferred embodiments of representative labels are further described in conjunction with FIGS. 3, 3a, 3b, 3c, and 3d below.

Document input mechanism 110 is any type of device which is capable of scanning or imaging a document. For paper-based documents, flatbed scanners, drum scanners, digital copiers, fax machines, multi-function copiers (“mopiers”), etc. are all examples of document input mechanisms 110 which can be used in various embodiments of the present invention. The purpose of document input mechanism 110 is to scan/image a paper-based document and create a computer file that contains a digital image of a paper-based document. This file is then stored on image storage mechanism 130. In addition, digital transmission of e-mail, faxes etc. may also be considered to be various forms of document input mechanism 110. If the document is already a digital image, then there is no need to scan the document, and the image can be stored according to the method described in FIGS. 7, 7a, or 7b below.

Image storage mechanism 130 represents large scale secondary storage for storing images which are scanned/imaged by document input mechanism 110. Various components such as hard disk drives, recordable CD-ROM/DVD drives and jukeboxes, magnetic tapes, and other devices known to those skilled in the art may be used to implement image storage mechanism 130. Digital document images captured by document input mechanism 110 may be transmitted to image storage mechanism 130 via communication link 120. Digital document images stored on image storage mechanism 130 may be transmitted to computer 200 via communication link 120. Image storage mechanism 130 may contain removable, transportable, image storage media, such as magneto-optical media, a DVD disk, or a CD-ROM disk.

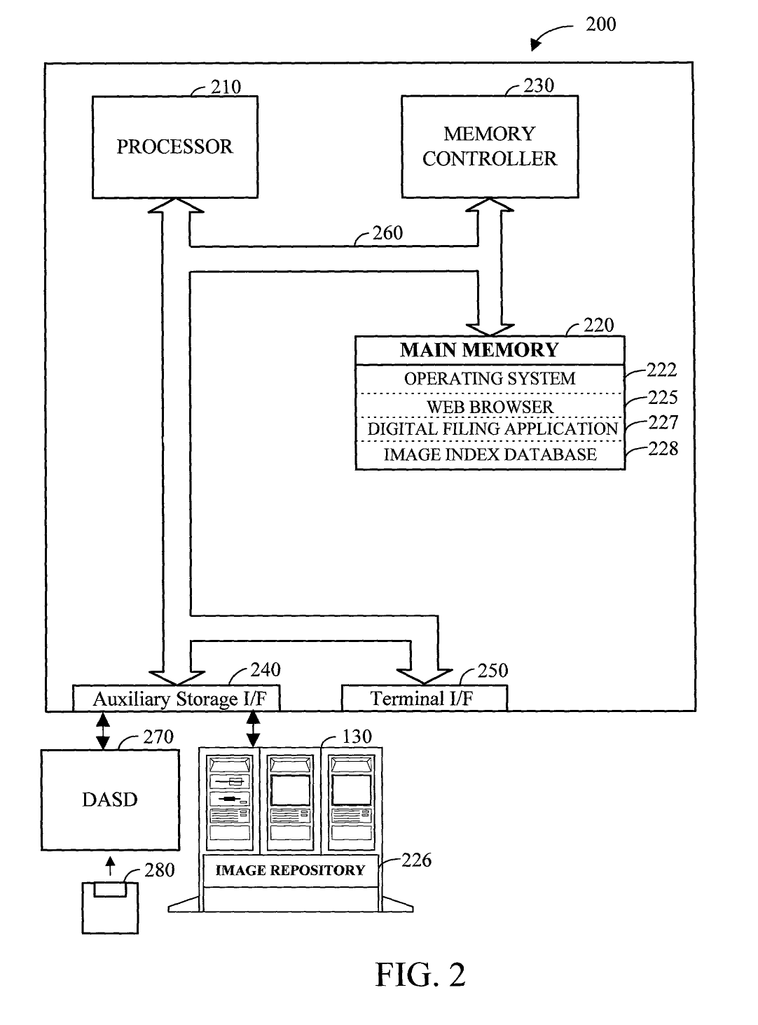

Communication link 120 is any suitable computer communication link or communication mechanism, including a hardwired connection, an internal or external bus, a connection for telephone access via a modem or high-speed T1 line, infrared or other wireless communications, computer network communications over the Internet or an internal network (e.g. “intranet”) via a wired or wireless connection, or any other suitable connection between computers and computer components, whether currently known or developed in the future. It should be noted that portions of communication link 120 may be a dial-up phone connection, broadcast cable transmission line, Digital Subscriber Line, ISDN line, or similar public utility-like access media. Computer 200 is further described in conjunction with FIG. 2 below.

In operation, a paper-based document is received by a user of system 100. The user will use system 100 to index the document. Indexing a document is the process of assigning “meta-data,” thereby describing the document and/or the contents of the document, and using the computer to capture the meta-data. The meta-data, or indexing information, is stored in a record in an image index database at the time of indexing. System 100 generates or coordinates a globally unique identifier for the paper-based document at the point of indexing. Since system 100 tracks each unique globally unique identifier, it can sequence through a series of pre-programmed globally unique identifiers in a pre-programmed fashion. This sequence will match the sequence of the pre-printed labels exactly. Thus, the user can place a label containing the globally unique identifier from label dispenser 202 onto the paper-based document. Since system 100 is tracking the globally unique identifiers, the globally unique identifier on the label can be matched to the next sequential globally unique identifier available in system 100.

Since the two globally unique identifiers match, the globally unique identifier is used to effectively link the document image to the record in the database, facilitating later retrieval of the document image, typically via the indexes. It should be noted that the most preferred embodiments of the present invention would include physical location of the paper-based document as one of the indices used in indexing the paper-based document. This will allow for later retrieval of the paper-based documents via the globally unique identifier. In an alternative preferred embodiment of the present invention, computer 200 communicates with a desktop label printer which generates a label for the paper-based document that contains the globally unique identifier and any other descriptive information used to identify the document (this could include, for example, meta-data such as document title, author, date, or physical storage location of the paper-based document), or uses a desktop labeling mechanism to print the globally unique identifier directly onto the document. In any case, the software associated with system 100 provides the capability to “auto-increment” the globally unique identifier, automatically creating or synchronizing the next identifier with the next identifier printed on the pre-printed labels.

After the globally unique identifier has been applied to the first page of the paper-based document, the document may be stored in folding out basket 203 until the document is ready to be introduced into system 100 using document input mechanism 110. In some preferred embodiments of the present invention, instead of placing a globally unique document identifier on the first page only, a separate identifier may be placed on each page of a paper-based document prior to scanning. When the paper-based document is subsequently scanned, an image of the paper-based document (including the globally unique identifier) is created and the previously-determined globally unique identifier is extracted. After imaging/scanning, the image of the paper-based document is stored in an image repository in a default storage location, such as on image storage mechanism 130, using the previously generated globally unique identifier as the basis for the image file name for the image, thereby linking the document image to a record in an image index database. In some embodiments of the present invention, the globally unique identifier will be the file name or will form the basis for creating the file name used in naming the digital image of the paper-based document, thereby linking the paper-based based document and the subsequently created digital image of the paper-based document.

Communication link 120 provides for communication between the various components of system 100 and allows the document image to be transmitted from device to device. In this fashion, a user can quickly and easily gain access to the electronic images of paper-based documents. Examples of communication link 120 include a Local Area Network (LAN), an Intranet, or the Internet. The connection made by communication link 120 may also be wireless. Communication link 120 logically links the physical components of system 100 together, regardless of their physical proximity. This is especially important because in many preferred embodiments of the present invention, it is anticipated that computer 200, document input mechanism 110, and image storage mechanism 130 may be geographically remote and that the indexing process, scanning/imaging process, and storage process will occur in sequential order but will be operationally independent. By labeling the document prior to scanning, and by pre-establishing the image identifier and including the identifier in the label, this method removes the need for any other communication or direct connectivity between the index, scan, and storage processes.

The image of the paper-based document carries embedded within it the image of the globally unique identifier and, correspondingly, the information necessary to link the index, scan, and storage processes, when and as necessary. In addition, by associating or assigning a given group of pre-printed labels containing unique globally unique identifiers to an individual or group of individuals, greater security measures can be afforded to the digital images of the paper-based documents, once the paper-based documents are scanned. By examining the globally unique identifier extracted from the digital image, “ownership” of the digital image can be established without further human intervention. Access to the digital images can then be controlled, as desired.

While designed primarily to deal with incoming paper-based documents, as mentioned earlier, it is also contemplated that incoming electronic documents (e-mail, documents downloaded from the Internet, etc.) could also be indexed and stored using system 100. In the case of electronic documents, the scanning/imaging of the document would not be necessary. In the case of electronic documents, the label containing the globally unique identifier could be printed directly onto the lead page of a document. Then, when the document is subsequently scanned, the globally unique identifier can be used to link the image of the document to a database containing the metadata for the document image. This is especially useful in situation such as delivery receipts, where an invoice is generated by a company, sent out for delivery, signed at the point of delivery and then returned to the point of origin for proof of delivery.

Referring now to FIG. 2, a computer 200 in accordance with a preferred embodiment of the present invention is an IBM compatible personal computer system. However, those skilled in the art will appreciate that the methods and apparatus of the present invention apply equally to any computer system, regardless of whether the computer system is a complicated multi-user computing apparatus or a single user device such as a personal computer or workstation. Specifically, it is envisioned that a hand-held computer or palm computing device may perform all or substantially all of the functions described in conjunction with computer 200.

Computer 200 suitably comprises at least one Central Processing Unit (CPU) or processor 210, a main memory 220, a memory controller 230, an auxiliary storage interface 240, and a terminal interface 250, all of which are interconnected via a system bus 260. Note that various modifications, additions, or deletions may be made to computer system 200 illustrated in FIG. 2 within the scope of the present invention such as the addition of cache memory or other peripheral devices. For example, computer 200 will also include a monitor or other display device (not shown) connected to the system bus 260. Alternatively, it is anticipated that computer 200 may be a terminal without a CPU that is connected to a network as a network computer (NC). In that case, the responsibilities and functions of CPU 210 will be assumed and performed by some other device on the network. FIG. 2 is not an exhaustive illustration of any specific computer system or configuration, but is presented to simply illustrate some of the salient features of one preferred embodiment for computer system 200.

Processor 210 performs computation and control functions of computer 200, and may comprise a single integrated circuit, such as a microprocessor, or may comprise any suitable number of integrated circuit devices and/or circuit boards working in cooperation to accomplish the functions of a processor. Processor 210 typically executes and operates under the control of an operating system 222 within main memory 220.

Auxiliary storage interface 240 allows computer 200 to store and retrieve information from auxiliary storage devices, such as image storage mechanism 130, magnetic disk drives (e.g., hard disks or floppy diskettes) or optical storage devices (e.g., CD-ROM). One suitable storage device is a direct access storage device (DASD) 270. As shown in FIG. 2, DASD 270 may be a floppy disk drive which may read programs and data from a floppy disk 280. It is important to note that while the present invention has been (and will continue to be) described in the context of a fully functional computer system, those skilled in the art will appreciate that the various mechanisms of the present invention are capable of being distributed as a program product in a variety of forms, such as via recordable media or transmission media and that the present invention applies equally regardless of the particular type or location of signal bearing media used to actually carry out the distribution. Examples of signal bearing media include: recordable type media such as floppy disks (e.g., disk 280) and CD ROMS, and transmission type media such as digital and analog communication links, including wireless communication links.

Memory controller 230, through use of a processor (not shown) separate from processor 210, is responsible for moving requested information from main memory 220 and/or through auxiliary storage interface 240 to processor 210. While for the purposes of explanation, memory controller 230 is shown as a separate entity, those skilled in the art understand that, in practice, portions of the function provided by memory controller 230 may actually reside in the circuitry associated with processor 210, main memory 220, and/or auxiliary storage interface 240.

Terminal interface 250 allows system administrators and computer programmers to communicate with computer system 200, normally through programmable workstations. Although computer 200 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Main memory 220 suitably contains an operating system 222, a web browser 225, a digital filing application 227; and an image index database 228. The term “memory” as used herein refers to any storage location in the virtual memory space of computer 200. It should be understood that main memory 220 will not necessarily contain all parts of all mechanisms shown. For example, portions of operating system 222 may be loaded into an instruction cache (not shown) for processor 210 to execute, while other files may well be stored on magnetic or optical disk storage devices (not shown). In addition, although image index database 228 is shown to reside in the same memory location as operating system 222, it is to be understood that main memory 220 may consist of multiple disparate memory locations.

Operating system 222 includes the software which is used to operate and control computer 200. Operating system 222 is typically executed by processor 210. Operating system 222 may be a single program or, alternatively, a collection of multiple programs which act in concert to perform the functions of any typical operating system, which functions are well known to those skilled in the art.

Web browser 225 can be any web browser software application currently known or later developed. Examples of suitable web browsers 225 include Microsoft Internet Explorer and Netscape Navigator. It is anticipated the other vendors will develop web browsers that will be suitable for use with the various preferred embodiments of the present invention.

Image repository 226 can be any type of computer filing or storage structure known to those skilled in the art. In the most preferred embodiments of the present invention, image repository 226 is simply a directory or subdirectory or a series of directories or subdirectories containing a series of images where each image has a globally unique identifier, taken from the pre-printed labels or, alternatively, created and assigned as explained below in conjunction with FIGS. 5 and 6. In one preferred embodiment of the present invention, image repository 226 may be a Structured Query Language (SQL) compatible database file capable of storing records containing images. In another preferred embodiment of the present invention, image repository 226 is an image directory on a DVD or CD-ROM disk which can be easily transported from one geographic location to another.

In one preferred embodiment of the present invention, digital filing application 227 works in conjunction with web browser 225 to provide the various functions of the present invention including a user interface and indexing tools used to prepare a document for subsequent scanning/imaging and electronic filing. Alternatively, digital filing application 227 may be a stand-alone program product which does not use web browser 225 for additional functionality and operates over an office intranet, in conjunction with any typical network operating system such as Windows NT or Novell.

Digital filing application 227 also incorporates standard database management tools to provide record management capabilities (add, modify, delete, etc.) for image repository 226 and image index database 228 and various administrative utilities.

Preferably, image index database 228 is a Structured Query Language (SQL) compatible database file capable of storing information, including indexed document names, for the images stored in image repository 226. In addition, image index database 228 may be physically located in a location other than main memory 220. For example, image index database 228 may be stored on an external hard disk drive (not shown) coupled to computer 200 via auxiliary storage I/F 240. Alternatively, image repository 226 and image index database 228 may each be stored at different remote locations which are accessible via the Internet, by utilizing web browser 225.

It should be noted that an image or images from image repository 226 may be loaded into main memory 220 and/or a cache memory storage location (not shown) for viewing by digital filing application 227 and/or web browser 225. As is typical for web browsers, previously viewed images may be recalled by using a “back” or “forward” button. Since the present invention works with standard web browsers, this functionality will be available for images viewed using digital filing application 227. If a web browser is not utilized, any other standard image viewer may be employed. Since the images will be stored using industry standard formats such as portable document format (PDF) or tagged image file format (TIFF), those skilled in the art will recognize that there are many options for viewing images, including readily available system software and viewers that can be downloaded from the internet. In addition, the use of PDF and TIFF is not exhaustive, it is anticipated that various types of image formats may be used in various preferred embodiments of the present invention. The most preferred embodiments of the present invention also use the header of the digital image file to store index information related to the digital image. In this fashion, a complete restoration of image index database 228 can be reconstructed from image repository 226.

Referring now to FIG. 3, a sample label 300 in accordance with a preferred embodiment of the present invention is illustrated. As shown in FIG. 3, label 300 contains two separate portions, an eye-legible information portion 302 and a computer readable bar code portion 304. Eye-legible information portion 302 is provided as a convenience for the user of system 100 and provides basic information about a paper-based document or about how a given paper-based document is to be processed. Computer readable portion 304 is used to link and/or contain, transport, and store the globally unique identifier and meta-data to be used when the scanned image is stored on image storage mechanism 130 of FIG. 1.

While the information contained in these two different portions may be identical, for security reasons the information in these two different portions may be different. It should be noted that the actual use of a typical bar code symbology to encode the globally unique identifier anticipates the use of many different types of symbologies. This includes those symbologies that represent digital information as shading within an icon (2d bar code symbologies) or any other symbology capable of representing large quantities of information in a digital format. In many preferred embodiments, the preprinted globally unique identifier will simply be a globally unique number represented in a traditional bar code symbology such as Interleaved 2 of 5 or code 39. Also note that the bar code or machine readable portion of the label may include additional information, besides the globally unique identifier to be used when storing the digital image of the paper-based document. For example, information on physical location of the paper-based document, document disposition details, or additional index data for the document may also be contained in the bar code.

In addition to providing a globally unique identifier for each document, each label 300 acts as a document separator and each occurrence of a new label 300 will signify the beginning of a new document for digital filing application 227. This feature allows a stack of multiple documents to be scanned in a single operation without the necessity of manually inserting document separator sheets into the stack.

The most preferred embodiments of pre-printed labels used in conjunction with the present invention utilize the Interleaved 2 of 5 bar code symbology to represent the globally unique identifier for a digital image to be created in the future. When using pre-printed labels, digital filing application 227 is synchronized with the bar-coded numbers on the pre-printed labels. Digital filing application 227 allows a user of system 100 to easily increment or decrement the numbers used as globally unique identifiers to maintain synchronization, in case a user accidentally destroys a label. Since the pre-printed bar-coded numbers on the labels are sequential, once digital filing application 227 has been synchronized with the first pre-printed label, the numeric globally unique identifiers created by digital filing application 227 and numbers on the pre-printed labels advance in lock-step sequence. Once a roll or pad of labels has been expended, a new roll or pad of labels can be loaded and synchronized with digital filing application 227 once again.

Referring now to FIG. 4, a document holder 400 in accordance with a preferred embodiment of the present invention is shown. Document holder 400 comprises: a first layer 405; a second layer 410; and an attachment strip 415. In the most preferred embodiments of the present invention, first layer 405 is a substantially transparent layer and second layer 410 is a substantially opaque layer.

Attachment strip 415 is placed around the perimeter of document holder 400 between substantially transparent first layer 405 and substantially opaque second layer 410. As shown in FIG. 4, attachment strip 415 does not trace the entire perimeter of document holder 400 but does incorporate coverage of three of the four corners of document holder 400. Accordingly, at least one long edge and at least one short edge of substantially transparent first layer 405 and substantially opaque second layer 410 are joined by attachment strip 415. In this manner, substantially transparent first layer 405, substantially opaque second layer 410, and attachment strip 415 combine to form a “pocket-like” area for holding small pieces of paper and paper-based documents such as receipts 430, 435, 440, and 445. As shown in FIG. 4, receipts 430, 435, 440, and 445 are sandwiched between substantially transparent first layer 405 and substantially opaque second layer 410.

Substantially transparent first layer 405 is preferably manufactured from a thin yet sturdy film of plastic that is scratch-resistant and relatively flexible. Substantially transparent first layer 405 preferably comprises a non-glare surface that will allow digital images to be created without interfering with the normal operation of a scanning device such as document input mechanism 110 of FIG. 1. In at least one preferred embodiment of the present invention, substantially transparent first layer 405 is treated with an anti-static treatment process. This anti-static treatment process removes the static electricity charge frequently associated with plastic sheet and is used to prevent documents placed between substantially transparent first layer 405 and substantially opaque second layer 410 from inadvertently adhering to substantially transparent first layer 405. However, in another preferred embodiment of the present invention, substantially transparent first layer 405 is not treated with an anti-static treatment process and is, therefore, allowed to retain a static electricity property that causes documents placed between substantially transparent first layer 405 and substantially opaque second layer 410 to adhere to substantially transparent first layer 405. This feature may be used to secure the documents in place and to further bind substantially transparent first layer 405 and substantially opaque second layer 410 together.

Substantially opaque second layer 410 is a layer of paper or some other suitable non-transparent material and is the same size and shape as substantially transparent first layer 405. In the most preferred embodiments of the present invention, substantially opaque second layer 410 is printed with some indicia that may present instructions for the use document holder 400 and/or advertising messages promoting various products or brands.

Attachment strip 415 is a first attachment portion and is used to join parts of substantially transparent first layer 405 and substantially opaque second layer 410 together. In this embodiment, attachment strip 415 serves to join a portion of the perimeter edges of substantially transparent first layer 405 and substantially opaque second layer 410 together. This is important to keep receipts 430, 435, 440, and 445 firmly in place between substantially transparent first layer 405 and substantially opaque second layer 410. In the most preferred embodiments of the present invention, attachment strip 415 is a repositionable adhesive that allows substantially transparent first layer 405 and substantially opaque second layer 410 to be completely separated, if enough force is applied to separate the layers.

Attachment point 455 is a second attachment portion and is used to join parts of substantially transparent first layer 405 and substantially opaque second layer 410 together. In this embodiment, attachment point 455 is a small spot of repositionable adhesive that adheres to substantially opaque second layer 410 and can be used to selectively adhere a corner 420 of substantially transparent first layer 405 to substantially opaque layer 410. In this manner, receipts 430, 435, 440, and 445 can be inserted in place by lifting corner 420 away from substantially opaque second layer 420. Then, by pressing corner 420 back onto attachment point 455, receipts 430, 435, 440, and 445 can be held in place when document holder 400 is inserted into the feed mechanism of document input mechanism 110 of FIG. 1.

Attachment strip 415 and attachment point 420 further serve to prevent separation of substantially transparent first layer 405 and substantially opaque second layer 410 from each other. In use, one of the edges along which attachment strip 415 is formed should be the “leading edge” when document holder 400 is inserted into a feed mechanism for a scanning device. This ensures that substantially transparent first layer 405 and substantially opaque second layer 410 both pass through the feed mechanism at the same rate of travel. Otherwise, substantially transparent first layer 405 and substantially opaque second layer 410 may be separated and jam the feed mechanism or allow receipts 430, 435, 440, and 445 to be lost in the interior portion of document input mechanism 110 of FIG. 1.

In the most preferred embodiments of the present invention, attachment point 455 is an adhesive material similar to the “repositionable” adhesive found on the back side of a Post-it Note and attachment strip 415 is a more aggressive adhesive. The formulation and use of these various types of adhesives are well known to those skilled in the art.

In the most preferred embodiments of the present invention, attachment strip 415 and attachment point 420 are non-contiguous and attach non-contiguous portions of the perimeters of substantially transparent first layer 405 and substantially opaque second layer 410 together. This means that at least a portion of the perimeter of substantially transparent first layer 405 and substantially opaque second layer 410 are not joined by either attachment strip 415 or attachment point 420. In yet another preferred embodiment of the present invention, all or substantially all of the entire interior surface of substantially opaque second layer 410 is covered with an adhesive material similar to that found on the back side of a Post-it Note. This allows small documents to be positioned and held in place more securely within the interior of document holder 400.

By inserting document holder 400 through a scanning device such as document input mechanism 110 of FIG. 1, a digital image of receipts 430, 435, 440, and 445 can be created. In the most preferred embodiments of the present invention, the digital image of receipts 430, 435, 440, and 445 can be used in conjunction with digital filing system 100 as described in FIGS. 1 and 2, by affixing label 450 to the surface of substantially transparent first layer 405. Alternatively, without employing digital filing system 100, document holder 400 may simply be used to create paper-based photocopies of receipts 430, 435, 440, and 445 for other applications. In that specific case, label 450 may not necessarily be attached.

Once the desired images have been created, the documents may be removed from the interior of document holder 400 and document holder 400 may be re-used with other documents. Alternatively, the documents may be left in place and document holder 400 may be filed in a traditional paper-based filing system (i.e., file folder and/or filing cabinet). This method allows for convenient storage of documents that otherwise might be lost due to their smaller, non-standard size.

In the most preferred embodiments of the present invention, document holder 400 is advantageously sized at 8 ½ by 11 inches so as to be compatible with the feed mechanisms associated with most standard scanners, fax machines, copy machines, etc. However, document holder 400 may be fabricated in other sizes for specific applications.

Additionally, attachment strip 415 and attachment point 420 are configured to be as small as reasonably possible so as to allow more room inside document holder 400 for containing documents.

Finally, multiple document holders 400 may be stacked and scanned in a “batch mode” operation. Since the various layers of document holder 400 are non-adhesive on the exterior surfaces, there is no impediment to sequential feeding of multiple document holders 400 in conventional feed systems for standard scanners, fax machines, copy machines, etc.

While the invention has been particularly shown and described with reference to preferred embodiments thereof, it will be understood by those skilled in the art that various changes in form and details may be made therein without departing from the spirit and scope of the invention. For example, while second layer 410 has been described in the most preferred embodiments as a substantially opaque layer, it should be noted that it may, like first layer 405, be substantially transparent for certain applications.

1. An apparatus comprising:
a substantially transparent first layer;
a second layer;
a first attachment portion attaching at least a first portion of said substantially transparent first layer to said second layer; and
a second attachment portion, said second attachment portion selectively attaching at least a second portion of said substantially transparent first layer to said second layer.

2. The apparatus of claim 1 wherein said second layer comprises a substantially opaque layer.

3. The apparatus of claim 1 further comprising at least one piece of paper sandwiched between said substantially transparent first layer and said substantially opaque second layer.

4. The apparatus of claim 3 wherein said at least one piece of paper comprises a plurality of receipts.

5. The apparatus of claim 1 further comprising a label affixed to said substantially transparent first layer, said label comprising a globally unique identifier.

6. The apparatus of claim 5 further comprising at least one piece of paper sandwiched between said substantially transparent first layer and said substantially opaque second layer.

7. The apparatus of claim 6 further comprising:
at least one processor;
a memory coupled to said at least one processor;
a digital image of said label and said at least one piece of paper, said digital image residing in said memory;
a digital filing application residing in said memory and being executed by said at least one processor, said digital filing application extracting said globally unique identifier from said digital image, wherein said digital filing application uses said globally unique identifier to link said digital image to a computerized database record which was created prior to the creation of said digital image.

8. The apparatus of claim 7 wherein said digital filing application links said digital image to said database record by using at least a portion of said globally unique document number to create a file name for said digital image.

9. The apparatus of claim 1 wherein said first attachment portion and said second attachment portion are non-contiguous.

10. The apparatus of claim 1 wherein said substantially transparent first layer and said substantially opaque second layer each define a size and wherein said size is 8½ by 11 inches.

11. The apparatus of claim 1 wherein at least one side of said substantially opaque second layer is coated with a repositionable adhesive.

12. The apparatus of claim 1 wherein said substantially transparent first layer is treated with an anti-static process.

13. A method comprising the steps of:
providing a document holder, said document holder comprising a substantially transparent first layer and a substantially opaque second layer, wherein said substantially transparent first layer and said substantially opaque second layer are partially attached by a first attachment portion;
lifting a corner of said substantially transparent first layer, thereby partially separating at least a portion of said substantially transparent first layer from a substantially opaque second layer;
placing at least one piece of paper between said substantially transparent first layer and said substantially opaque second layer; and
attaching said corner of said substantially transparent first layer to said substantially opaque second layer with a second attachment portion.

14. The method of claim 13 further comprising the steps of:
placing said document holder into a document input mechanism; and
creating a photocopy of said at least one piece of paper.

15. The method of claim 14 wherein said step of placing at least one piece of paper between said substantially transparent first layer and said substantially opaque second layer comprises the step of placing a plurality of receipts between said substantially transparent first layer and said substantially opaque second layer.

16. The method of claim 13 further comprising the step of affixing a label to said substantially transparent first layer, wherein said label comprises a globally unique identifier.

17. The method of claim 13 further comprising the steps of:
affixing a label to said substantially transparent first layer, wherein said label comprises a globally unique identifier;
placing said document holder into a document input mechanism;
creating a digital image of said at least one piece of paper and said label;
extracting said globally unique identifier from said digital image; and
linking said digital image to a computerized database record which was created prior to the creation of said digital image.

18. The method of claim 14 further comprising the step of removing said at least one piece of paper from between said substantially transparent first layer and said substantially opaque second layer after creating said photocopy of said at least one piece of paper.

19. The method of claim 14 further comprising the step of storing said document holder in a file folder after creating said photocopy of said at least one piece of paper.

20. A method comprising the steps of:
placing at least one receipt between a substantially transparent first layer and a substantially opaque second layer;
affixing a label to said substantially transparent first layer, wherein said label comprises a globally unique identifier;
creating a record in a database describing said receipt;
processing said substantially transparent first layer, said substantially opaque second layer, said receipt and said label, thereby creating a digital image of said receipt and said label;
extracting said globally unique identifier from said digital image; and
storing said digital image, using said globally unique identifier to link said digital image to said record in said database.
